(19) United States
(12) Patent Application Publication
(10) Pub. No.: US 2012/0089239 A1
(43) Pub. Date: Apr. 12, 2012

(54) INTELLIGENT INTERFACE FOR A DISTRIBUTED CONTROL SYSTEM

(75) Inventors: Timothy M. Sentgeorge, Wickliffe, OH (US); David M. Carney, Strongsville, OH (US); Paul E. Hunkar, Hudson, OH (US)

(73) Assignee: ABB Inc., Cary, NC (US)

(21) Appl. No.: 13/234,726

(22) Filed: Sep. 16, 2011

Related U.S. Application Data
(60) Provisional application No. 61/392,467, filed on Oct. 12, 2010.

(51) Int. Cl. G05B 19/042

(52) U.S. Cl. 700/2

(57) ABSTRACT

An intelligent interface system is provided for connecting an external application to a distributed control system (DCS). The interface system is operable to automatically scan the DCS to determine its configuration and build a topology model of the DCS. The topology model is used to determine whether data requested from a module in the DCS can be provided by the module. The topology model is constructed to be thread-safe. A throttling mechanism in the interface system protects the DCS from being subjected to excessive data requests.

### CROSS-REFERENCE TO RELATED APPLICATION

This application claims the benefit of U.S. provisional patent application No. 61/392,467 filed on Oct. 12, 2010, which is hereby incorporated by reference in its entirety.

### BACKGROUND OF THE INVENTION

This invention relates to an interface for a distributed control system (DCS) and more particularly to an intelligent interface for a DCS.

A DCS is a system dedicated to the control of an industrial process, wherein the system is comprised of control modules that are not centrally located, but instead are distributed throughout the process, with each sub-process of the industrial process being controlled by one or more control modules. Other components of a DCS include input and output (I/O) modules and communication modules. Communication between the modules within a DCS often utilizes a proprietary protocol.

For a DCS with a proprietary communication protocol, an interface is often provided so that an external application or system, such as a maintenance management system or a supervisory system, can obtain information from and otherwise communicate with the DCS. A conventional DCS interface utilizes a static model or configuration of the DCS. This configuration is manually built using data points, which are typically referred to as “tags”. Tags include inputs, outputs, setpoints, measured variables, controller gains, module status, etc. The tags for the DCS configuration are manually entered in one of two ways. The tags can be directly entered into the interface or the tags can be entered into the interface from an engineering workstation database, which is manually built and verified. Either way, a user must manually enter the tags and ensure that the configuration is correct and up-to-date. This is important because errors in the configuration can cause improper operation of the control system.

In addition to the foregoing, a conventional DCS interface typically has no features to prevent improper or invalid commands from being sent to the DCS. Thus, improper or invalid commands sent through such an interface may cause a disruption of the DCS or even crashing certain devices which are part of the DCS.

Based on the foregoing, there is a need for an improved DCS interface that is easier to build and better protects the DCS. The present invention is directed toward such an interface.

### SUMMARY OF THE INVENTION

In accordance with the present invention, a method and an interface system are provided for connecting an external application to a distributed control system (DCS). The interface system includes computer readable media having instructions for causing a computer to execute the method. In accordance with the method, the DCS is scanned to determine its configuration. The determined configuration of the DCS is used to construct a topology model of the DCS. An external request for data from a module in the DCS is received from the external application. The topology model is used to determine whether the module is capable of providing the requested data.

### BRIEF DESCRIPTION OF THE DRAWINGS

The features, aspects, and advantages of the present invention will become better understood with regard to the following description, appended claims, and accompanying drawings where:

FIG. 1 is a schematic drawing of a first distributed control system (DCS) having a plurality of process control units;

FIG. 2 is a schematic drawing of the first DCS and a second DCS connected to a work station hosting a smart interface embodied in accordance with the present invention;

FIG. 3 is a schematic drawing of the smart interface;

FIG. 4 is a flow chart of a main routine of the smart interface;

FIG. 5 is a flow chart of a loop scan subroutine of the smart interface;

FIG. 6 is a flow chart of a node scan subroutine of the smart interface; and

FIG. 7 is a class structure used to store topology models of the smart interface.

### DETAILED DESCRIPTION OF ILLUSTRATIVE EMBODIMENTS

It should be noted that in the detailed description that follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

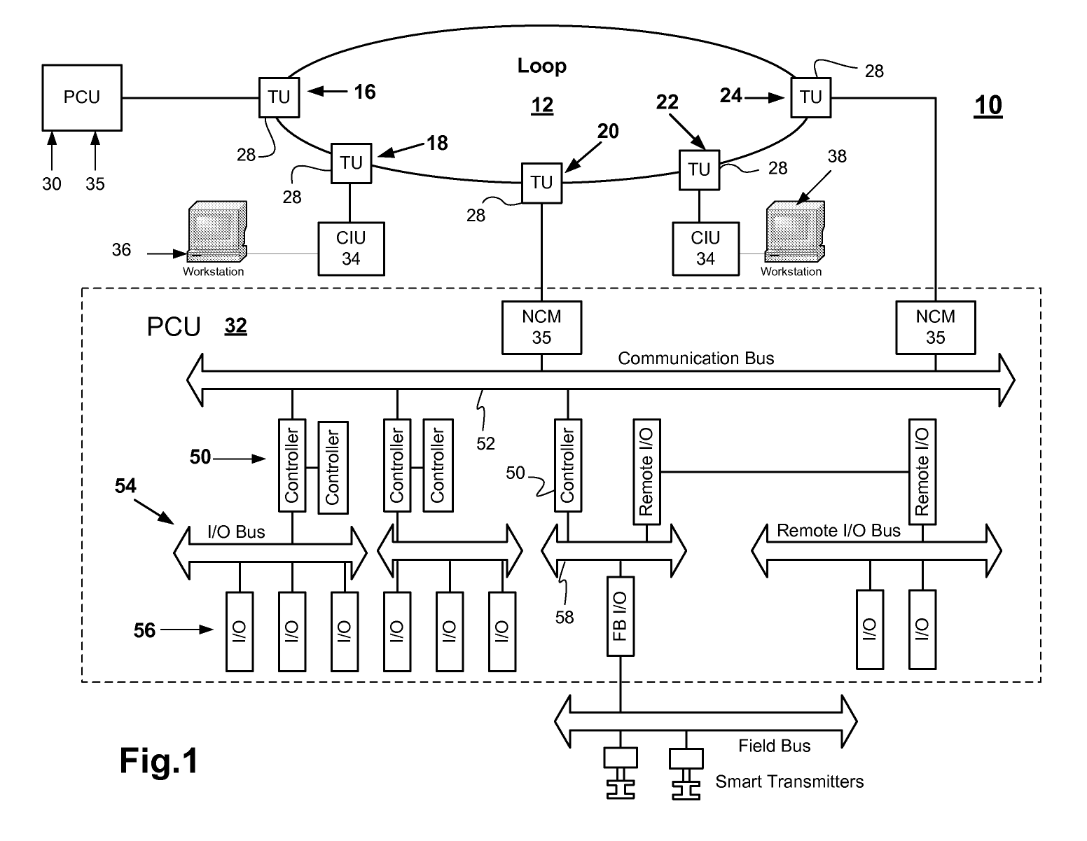

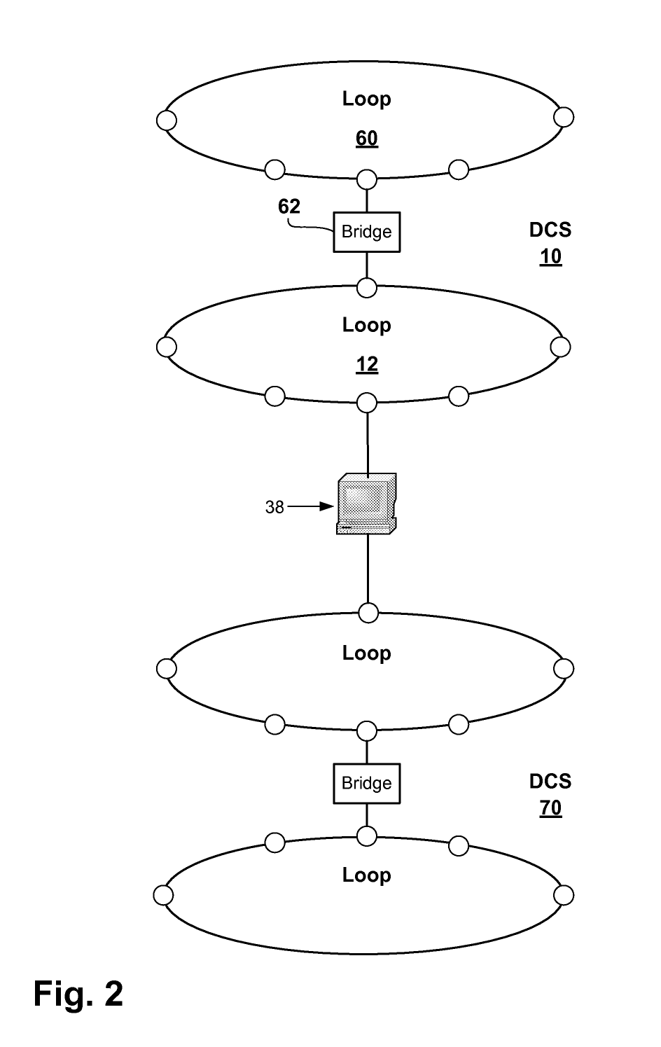

Referring now to FIG. 1, there is shown a schematic drawing of a DCS 10 with which the present invention may be used. The DCS 10 includes a loop 12 comprising one or more network cables 14 to which a plurality of nodes 16, 18, 20, 22, 24 are connected. Each node includes an electronic device or plurality of electronic devices that is/are connected to the loop 12 for communication with other nodes on the loop 12. Each node has a unique address on the loop and is connected to the loop 12 by a termination unit (TU) 28. Although only one loop is shown in FIG. 1, it should be appreciated that the DCS 10 may include a plurality of loops, such as is shown in FIG. 2. In one embodiment, the loop 12 is a unidirectional, high speed serial data network that operates at 10-megahertz or 2-megahertz communication rate.

The nodes 16, 20 comprise process control units (PCUs) 30, 32, respectively. As will be described in more detail below, each PCU 30, 32 comprises a network communication manager (NCM) module 35 and one or more controllers for controlling a process or sub-process in an industrial facility, such as a power generation plant, a paper mill or a chemical or manufacturing plant. The NCM module 35 monitors the controllers for outgoing data to package and routes and delivers incoming data to the controllers. Each controller may be redundant, and a PCU may contain a redundant NCM module 35 attached to the network on a second TU 28. Each of the nodes 16, 20 is connected to the loop 12 through a TU 28 and one or more NCM modules 35.

The nodes 18, 22 comprise computer interface units (ClUs) 34 with operator workstations 36, 38 connected thereto, respectively. Each workstation 36, 38 comprises a processor and associated memory as well as a monitor for displaying a graphical user interface (GUI) through which operators may monitor and manually control the processes and sub-processes in the facility. Each workstation 36, 38 is connected to the loop 12 through a CIU 34 and a TU 28. The CIU 34 may be separate from or integrated into a workstation but is a part of the DCS 10. For ease of illustration, the ClUs 34 associated with the workstations 36, 38 are integrated with the workstations 36, 38. As will be described in more detail below, a smart interface system 44 is stored in memory of the workstation 38 and is executed by one or more processors of the workstation 38.

The PCU 32 comprises a plurality of microprocessor-based controllers 50 connected to a communication bus 52, which may be a serial communication system with an Ethernet-like protocol. Each controller 50 contains one or more control programs (or configurations) for controlling one or more sub-processes (or loops) of the industrial facility. The control programs utilize operating values received from field devices through one or more I/O subsystems 54. Each single controller 50 or redundant controller 50 pair may have a separate I/O subsystem 54. The control programs may be written in one or more of the five IEC 61131-3 standard languages: Ladder Diagram, Structured Text, Function Block Diagram, Instruction List and Sequential Function Chart. In addition, the control programs may be written in traditional programming languages such as C. In one embodiment of the present invention, the control programs are written in Function Block Diagram. Outputs from the control programs are transmitted to the control devices of the field devices through the I/O subsystem 54. The I/O subsystem 54 includes a plurality of I/O modules 56 connected to an I/O bus 58. The controllers 50 are also connected to the I/O bus 58 to receive the operating values from the I/O modules 56.

Generally, the PCU 30 has a configuration similar to the PCU 32, i.e., the PCU 30 has a plurality of controllers, a communication bus and an I/O subsystem.

Referring now to FIG. 2 there is shown an embodiment of the present invention, wherein an enterprise has the (first) DCS 10 and a second DCS 70. In addition, the first DCS 10 is shown with a second loop 60, which has a configuration similar to the (first) loop 12, i.e., the second loop 60 has one or more PCUs, each with a plurality of controllers, a communication bus and an I/O subsystem. The first and second loops 12, 60 are connected by a bridge module 62. The second DCS 70 has a configuration similar to the DCS 10, i.e., the DCS has one or more loops, each with one or more PCUs, each of which comprises a plurality of controllers, a communication bus and an I/O subsystem. As shown, the workstation 38 and the smart interface system 44 running thereon are connected to both the DCS 10 and the DCS 70.

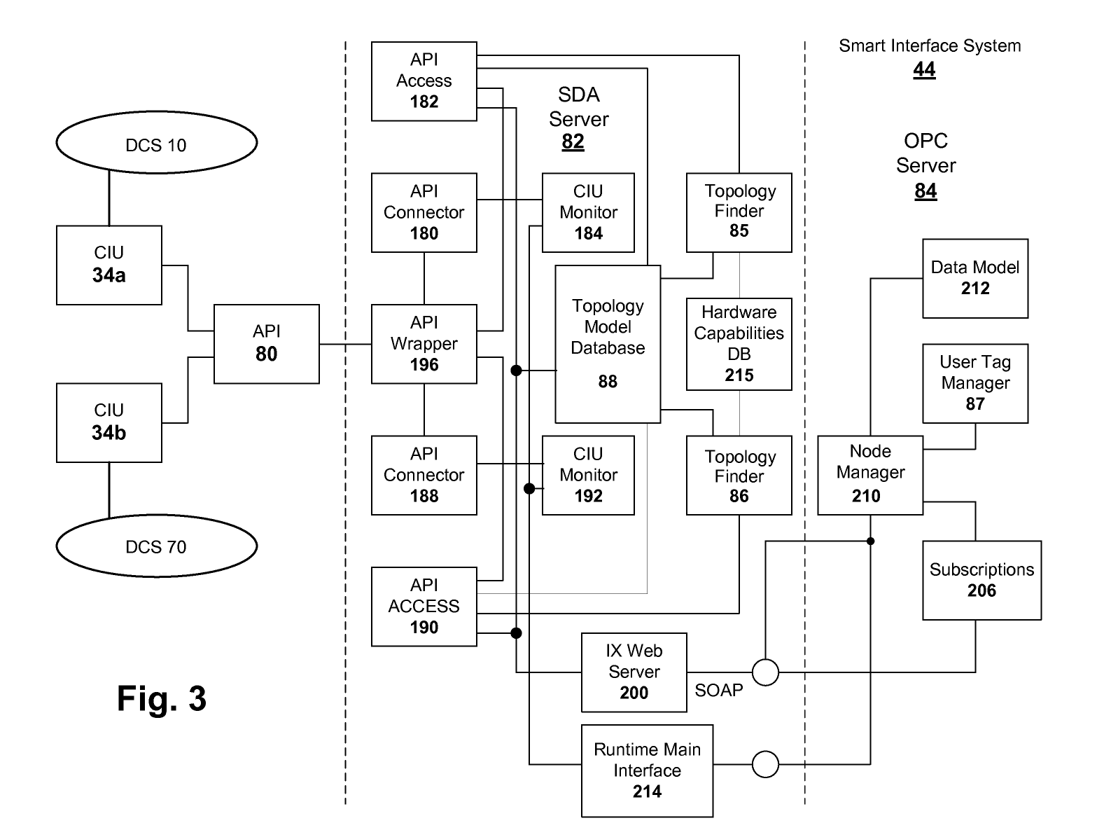

Referring now to FIG. 3, there is shown a schematic representation of the smart interface system 44, which is a software system that is operable to automatically provide an interface between one or more external applications and the DCSs 10, 70. As shown, the smart interface system 44 generally comprises a software application interface (API) 80, a system data access (SDA) server 82 and an OPC server 84. The API 80 is a low level interface comprising a set of ‘C’ language subroutines that provide access to a native language command set in a CIU 34. Each CIU 34 is comprised of one or more hardware modules that connect a microprocessor-based device (such as workstation 36 or 38) or a PCU (e.g. PCU 30 or 32) to a loop (e.g. loop 12). In one embodiment, each CIU 34 comprises a network interface module and a network to computer transfer module. In this embodiment, each CIU 34 can handle four message types: broadcast, time-synchronization, multicast and polling. In addition, all messages contain cyclic redundancy check codes and checksums to insure data integrity.

The SDA server 82 is highly adaptable and may be used with one or a plurality of DCSs (e.g., two, three, four etc. DCSs). For each DCS connected to the SDA server 82, instances of an API Access, an API Connector a CIU monitor and a topology finder are created. In addition, the SDA server 82 includes an API wrapper 196 and a topology model database 88.

In the embodiment shown in FIG. 3, the SDA server 82 interfaces with two DCSs, namely the DCS 10 and the DCS 70 and includes a topology finder 85 for the DCS 10 and a topology finder 86 for the DCS 70. Each topology finder is operable upon start-up of the SDA server 82 to discover the topology of its associated DCS and create a topology model of the DCS. These topology models are stored in the topology model database 88. The topology model database 88 contains the models of all DCSs to which the SDA server 82 is connected, which in this case includes DCS 10 and DCS 70. As will be described more fully below, the topology model database 88 is used as an internal reference to control the type of communication that can occur with any connected DCS.

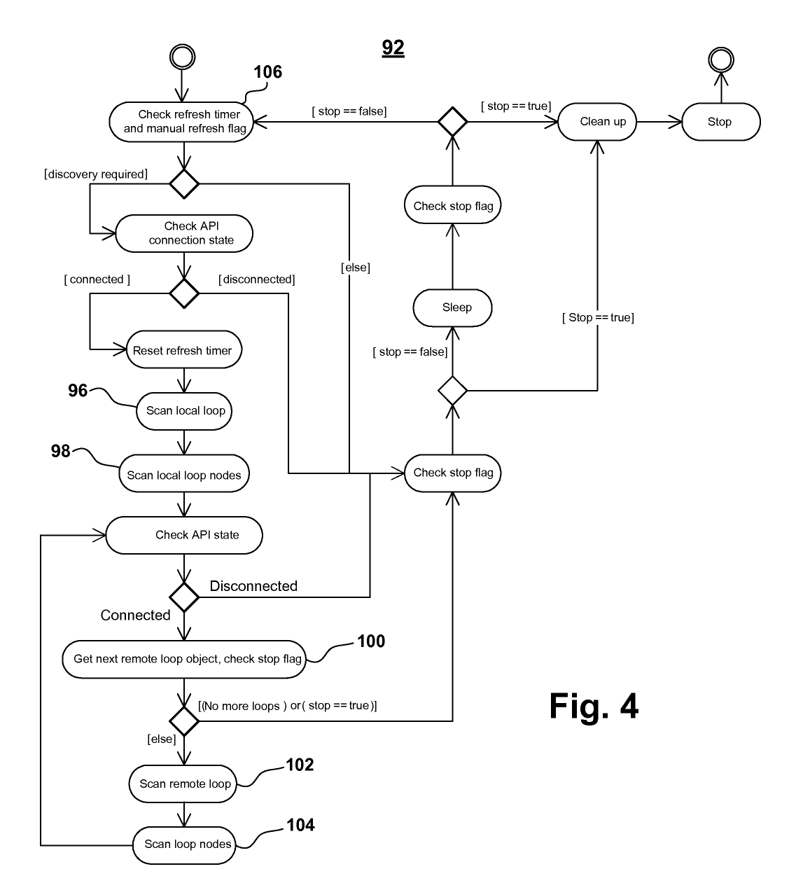

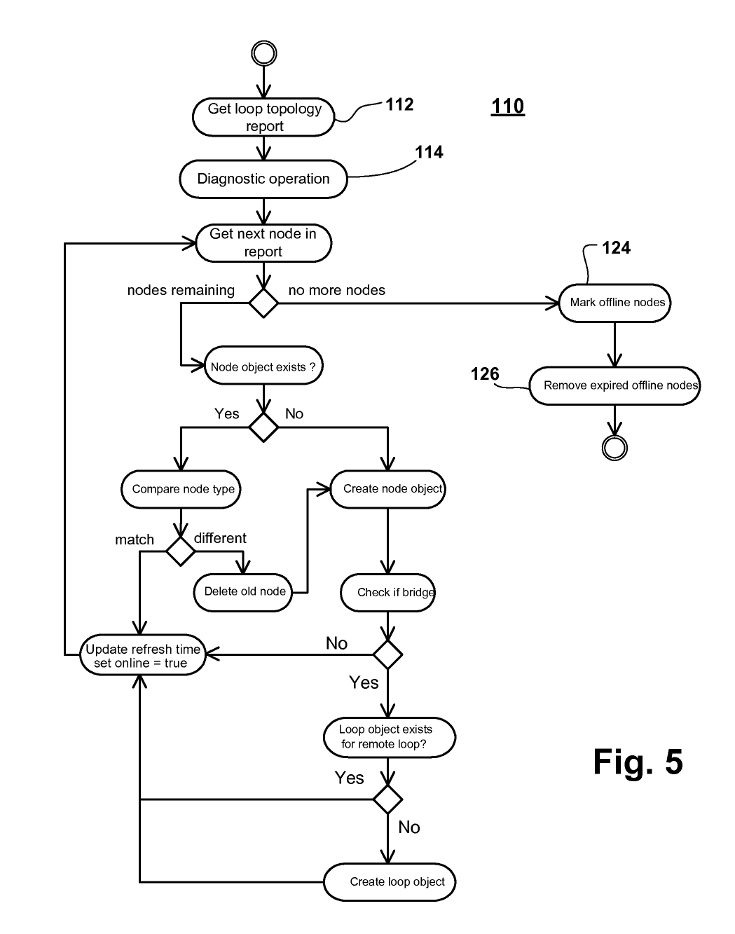

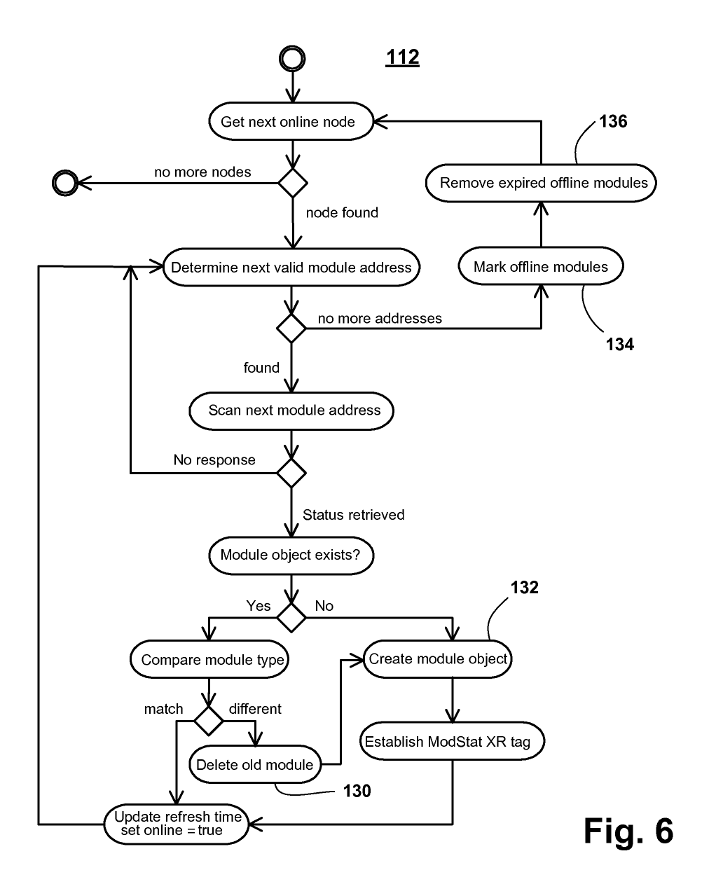

A main routine 92 of a topology finder is shown in FIG. 4. In a step 96, the main routine 92 invokes a loop scan subroutine 110 (shown in FIG. 5) to first scan the loop to which the smart interface system 44 belongs (i.e., the local loop), which in the embodiment of FIG. 3 is the loop 12. After the completion of step 96, the main routine 92 proceeds to step 98, wherein the main routine 92 invokes a node scan subroutine 112 (shown in FIG. 6) to scan the nodes (e.g. nodes 16-24) of the local loop (e.g. loop 12). After the local loop and the nodes of the local loop are scanned, the main routine 92 proceeds to step 100 wherein a check is made if there is another loop to scan. If there is another loop to scan, the main subroutine proceeds to the next loop (e.g. loop 60) and in step 102, invokes the loop scan subroutine to scan the next loop. After step 102, the main routine 92 proceeds to step 104, wherein the main routine 92 invokes the node scan subroutine to scan the nodes of the next loop. Steps 100-104 are repeated until there are no more loops to scan or the API is determined to be disconnected. Once all of the loops in a DCS have been scanned, the topology model of the DCS is complete and the main routine 92 returns to step 106

The loop and node scanning procedures of the main routine 92 are periodically performed to update the topology model of the DCS. When a timer indicates that a predetermined period of time has elapsed, the main routine 92 proceeds from step 106 through a number of steps down to step 96 to again perform the loop and node scanning steps described above.

Referring now to FIG. 5, there is shown a flow chart of the loop scan subroutine 110. In a step 112, the loop scan subroutine 110 generates a loop topology report for the present loop. The loop topology report includes a list of all of the nodes in the present loop and contains identifying information for each node. For example, the identifying information may include the address of the node, the type of the node (e.g. process control, computer interface, bridge interface, sequence of events, or other) and the electrical/logical position of each node on the loop (the node order). In step 114, the loop scan subroutine 110 performs a diagnostic operation, wherein available diagnostic information is reviewed to determine if there is a communication problem in any of the loops. If there is a communication problem in one of the loops, the problem is marked (flagged) so that the problem may be visually identified in a display in a connected external application. After step 114, the loop scan routine proceeds to a series of steps in which the topology model is created or updated (depending on whether the scan is an initial or update scan) using the loop topology report.

If any node is found in a loop topology report that does not already have a corresponding object in the existing topology model, a new object is created to represent that node and is added to the topology model. If the node happens to be a bridge to a remote loop, a new loop object is also created and added to the topology model.

If a node is found in a loop topology report that is already represented in the existing topology model, the type of the discovered node will be compared to the node object in the existing topology model. If the node types do not match, the existing node object is discarded and replaced with a new node object that represents the current topology (as represented by the loop topology report).

If a node corresponding to a node object in the existing topology model is no longer present in a current loop topology report, the node is marked as offline in step 124. Any node that is offline longer than a user selectable duration is considered to be permanently removed from the DCS and its corresponding node object is removed from the topology model in step 126. This duration can be adjusted according to plant conditions—during maintenance it may be weeks, but during normal operation it is usually less than 10 minutes or the time required to reset a node. When a node object is removed from the topology model, all module objects that were previously part of that node object are also removed.

Referring now to FIG. 6, there is shown a flow chart of the node scan subroutine 112. The node scan subroutine 112 scans a particular node for all modules associated with that node. The information obtained from this scan is used to create or update the topology model, depending on whether the scan is an initial or update scan. The node scan subroutine 112 scans a particular node by sending a status request message to each possible module address in the node. If a good response is received from a module at a particular address, then the module is known to be present and online. If no response or a bad response is received, then the targeted module is determined to not be present.

If there is a module object in the topology model at the same address as a module discovered by the node scan subroutine 112, then the module types of the object and the discovered module are compared. If the module type of the object does not match the discovered module, then the object is deleted in step 130 and replaced with a new object in step 132 to represent the discovered module. As part of step 132, the node scan subroutine 112 looks up the module type of the discovered module in a hardware capabilities database 215 to determine the known capabilities of that module type and stores this information along with the module object in the topology model in the topology module database 88. If a status request message is sent to a module at the same address as a module object in the topology model and no response or a bad response is received back, then the module at that address will be marked “offline” in step 134. If a module remains offline longer than a user selectable duration, then the module is considered to be permanently removed from the DCS and its corresponding module object is removed from the topology model in step 136. This duration can be adjusted according to plant conditions—during maintenance it may be weeks, but during normal operation it is usually less than 5 minutes or the time required to reset a module.

After a new module object is created in step 132, the node scan subroutine 112 proceeds to step 140, wherein the subroutine creates a module status exception report tag (ModStat XR tag) in the CIU 34 for the module corresponding to the newly created module object, provided the module can support a ModStat XR tag. The node scan subroutine 112 determines whether a module can safely support a ModStat XR tag based on the type of the module. For example, main controllers (such as controllers 50) can support ModStat XR tags, but back-up controllers, some communication modules, and I/O modules cannot. An exception report from a ModStat XR for a main controller, however, will contain information about a back-up controller and I/O modules associated with the controller. And a ModStat XR from an intelligent communication module will contain information about its paired network interface module. A ModStat XR tag permits a significant amount of information to be collected from a module and reported in exception reports. Such information includes the type of the module, the operating state of the module (e.g., configure, execute, etc.), error states of various communication channels used by the module and problems with the module's power supply. Exception reports from modules are temporarily stored in the connected CIU 34 and are then collected and stored in the topology model. In the CIU 34, when an exception report from a point (either a process value or a module status tag) is received, the previous exception report is overwritten. Accordingly, the CIU 34 is frequently polled to obtain rapid state changes. In some embodiments, the status and process information is obtained by polling instead of exception reporting.

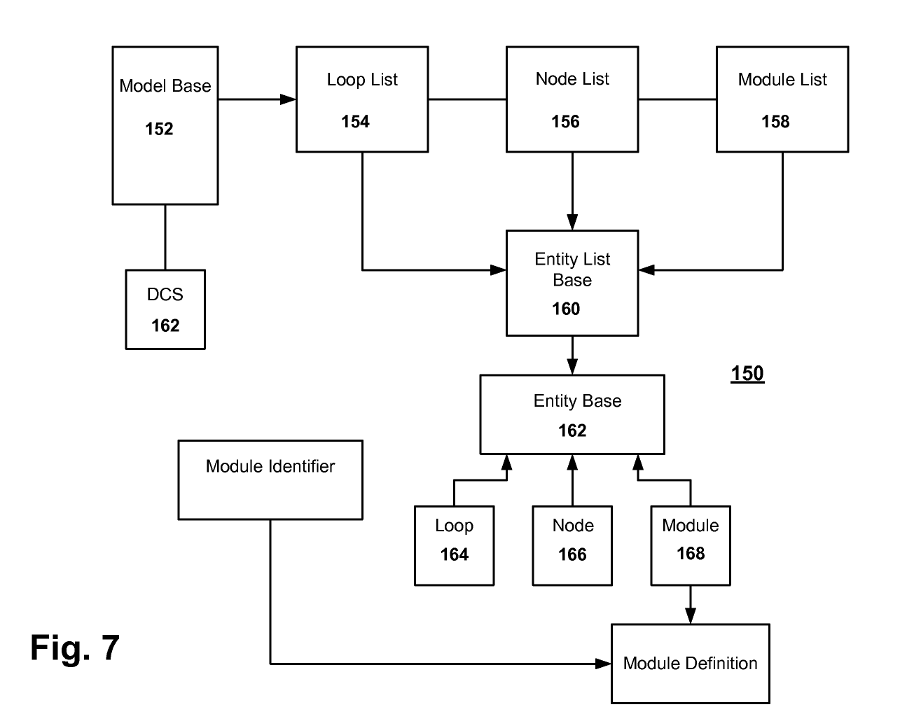

The topology model database 88 is generated and stored using different classes of objects. Referring now to FIG. 7, there is shown a class structure 150 used to store the topology model database 88. As shown, the class structure 150 includes a model class 152, a loop list class 154, a node list class 156 and a module list class 158.

The model class 152 provides information about all topological models for an enterprise and enables the modification of these topological models. The model class 152 can provide information about all DCSs, loops, nodes and modules in the enterprise and enables the addition and removal of objects for the foregoing from the topological model(s). The model class 152 obtains information about the DCSs using calls to a DCS class 162 and obtains information about loops, nodes and modules using calls to the loop list class 154.

The loop list class 154 provides information about all loops, nodes and modules in the enterprise and enables the addition and removal of objects for loops from the topological model(s). The loop list class 154 obtains information about the loops using calls to an entity list base class 160 and obtains information about nodes and modules using calls to the node list class 156.

The node list class 156 provides information about all nodes and modules in the enterprise and enables the addition and removal of objects for nodes from the topological model(s). The node list class 156 obtains information about the nodes using calls to the entity list base class 160 and obtains information about modules using calls to the module list class 158.

The module list class 158 provides information about all modules in the enterprise and enables the addition and removal of objects for modules from the topological model(s). The module list class 158 obtains information about the modules using calls to the entity list base class 160.

The entity list base class 160 obtains information about loops, nodes and modules from a loop class 164, a node class 166 and a module class 168, respectively, through an entity base class 162. The module class 168, in turn, obtains detailed information about a module from a module definition class 170 and a module identifier class 172.

The topology models are thread-safe, i.e., data is not permitted to be read when changes are being made that affect the data and vice versa. The structure of the class structure 150 permits this thread-safety to be implemented in a graduated and granular manner. More specifically, read/write locks are implemented in each class of the class structure 150. Thus, a read/write lock is implemented on a DCS object in the model class 152 to: (1.) prevent any information about the DCS object from being read if the DCS object is being added or removed from the topology model(s) of the enterprise, and (2.) prevent the DCS object from being added or removed from the topology model(s) if information is being read from the DCS object. Similarly, a read/write lock is implemented on a loop object in the loop list class 154 to: (1.) prevent any information about the loop object from being read if the loop object is being added, changed, or removed from the topology model(s) of the enterprise, and (2.) prevent the loop object from being added, changed, or removed from the topology model(s) if information is being read from the loop object. Continuing on down the hierarchy of classes, similar read/write locks are placed on node objects and module objects in the node list class 156 and the module list class 158, respectively. Read/write locks in the loop class 164, the node class 166 and the module class 168 provide even more granular locking capabilities. For example, a read/write lock is implemented on each object instance of module class 168 to: (1.) prevent any information about the module from being read if the module is being configured or updated, and (2.) prevent the module from being configured, updated, or removed if the module is being read.

From the foregoing, it should be appreciated that the configuration of the class structure 150 provides thread safety without unduly interfering with the operation of the SDA server 82. More specifically, the configuration permits a read/write lock to be directed to only that portion of a DCS that needs to be locked. For example, if only two modules in two different nodes in a loop of a DCS need to be locked because, for example, they are being configured, locks are implemented only on those two modules, instead of on both nodes, or on the entire loop or on the entire DCS, as would be the case if the model objects were arranged in a simple hierarchical manner.

Referring back to FIG. 3, in addition to the topology model database 88 and the topology finders 85, 86, the embodiment of the SDA server 82 for the DCSs 10, 70 comprises an API Connector 180, an API Access 182 and a CIU monitor 184 for the CIU 34a (DCS 10), and an API Connector 188, an API Access 190 and a CIU monitor 192 for the CIU 34b (DCS 170).

Each API Connector 180, 188 establishes and closes connections to its associated CIU 34 via the API 80. In addition, each API Connector 180, 188 includes a point manager object that assigns and tracks indices used for a point database in its associated CIU 34. Any time a CIU 34 is restarted, the point manager object in its associated API Connector is deleted and a new one is created since restarting the CIU 34 clears the point database.

Each CIU monitor 184, 192 interacts with its associated API Connector to establish, maintain and restart a connection in its associated CIU 34. In addition, the CIU monitor checks the status of the connections at configured intervals. During each execution cycle, the CIU monitor retrieves exception reports from its associated CIU 34 and will check the state of its associated API Connector. If its associated API Connector is found to be offline or disconnected, the CIU monitor will try to re-establish a connection between the API Connector and the CIU 34.

Each API Access 182, 190 is operable, in a controlled manner, to transmit requests to and receive responses from its associated DCS through its associated CIU 34 and the API 80. The API Access may be easily modified so as to be usable with communication modules other than the CIU 34 and software application interfaces other than the API 80. In addition, the API Access is also operable to retrieve diagnostic data from the DCS via the CIU 34 and the API 80. Diagnostic data includes memory usage, error counters, communication metrics, firmware levels, program execution metrics, error states. The API Access has a reference (pointer) to an associated API Connector, but performs only status reads and updates on the API Connector. The API Access transmits requests using a throttling mechanism that controls the rate of communication. The throttling mechanism uses a polling period, which is the required time between the initiation of requests. If a second call is made to the API Access to issue a second request before the polling period of a previous first call has elapsed (as measured from the time the call to API Access was initiated), the second request will be delayed until the polling period of the first call elapses. In addition, if a second call for a second request is made to the API Access before a previous first request has been completed, a read/write lock will prevent the second request (and any subsequent requests) from being sent until the first request is completed. When the first request is completed, the read/write lock will be released when the poll period elapses and made available to the next in line thread.

The components (classes) of the SDA server 82 utilize Common Language Runtime (CLR), which is a core component of Microsoft's .NET initiative. In the CLR, code is expressed in a form of bytecode called the Common Intermediate Language (CIL). In contrast to the SDA server 82, the API 80 uses native ‘C’ libraries. Thus, an API wrapper 196 is provided and is connected to the API Connectors 180, 188 and the API Accesses 182, 190. The API wrapper 196 translates requests from the components of the SDA server 82 into native ‘C’ calls for transmittal to the API 80, and translates the native ‘C’ structures, arrays and pointers received from the API 80 into native .NET data types used by the components of the SDA server 82.

A web server application 200 is provided to connect the SDA server 82 to any web client using Simple Object Access Protocol (SOAP). However, communication between the web server application 200 and clients is encrypted. In addition, client connections to the web server application 200 must be authenticated by connecting as a local account on the server (e.g., workstation 38) hosting the SDA server 82.

The SDA server 82 can handle data requests that are received by the web server application 200 and require information from multiple targets in a DCS. Such a multi-target data request is typically diagnostic and requires only a small amount of data from each target (for example, a single float value from a block read). The requested action is performed for each target, and the results of all requested actions are returned to the relevant API Access (182 or 190) at the same time. Specifying multiple targets in the request will lengthen the time before the request is completed and results can be returned, but it will result in fewer round trips and therefore overhead. This is useful in cases where many reads would otherwise be needed in a very short time and the resulting data would be very small (for example, requesting block reads from a controller module may be done with a single request to the web server application 200 instead of multiple requests). The number of targets that may be specified is unbounded, and it is up to the client application to make reasonable requests. Since throttling is performed by the relevant API Access, a request with a large number of targets will not flood the CIU 34.

Diagnostic data requests to the web server application 200 that request a large amount of data (e.g., a loop topology report) are typically only directed to a single target in the DCS.

The OPC server 84 is operable to publish data from the SDA server 82 via OPC UA and supports connections using both the TCP and HTTP OPC UA communication stacks. The OPC server 84 can perform reads and function calls (where necessary to perform an operation) and provide subscriptions 206. The OPC server 84 implements a custom node manager 210 and a custom OPC data model 212 that includes custom object types, custom complex variable types, custom enumerations, and methods.

The OPC server 84 connects to the SDA server 82 through two interfaces. Data (such as exception reports) autonomously discovered and monitored by the SDA server 82 is pushed to the OPC server 84 through a runtime main interface 214. Data that must be polled from the SDA server 82 is retrieved through the web server application 200.

The OPC server's custom node manager 210 can optionally launch an IX data handler thread to record data to a historian. Information recorded would include all discovered topology information and changes, exception reports, as well as any diagnostics data required to fulfill read requests to the OPC server 84 or client subscriptions.

The OPC server's custom node manager 210 can optionally utilize a user tag manager 87 component to allow users to safely configure process tags that they explicitly wish to have exposed. The user tag manager 87 loads user defined tag information from a database. As modules in the DCS (e.g., DCS 10 or 70) are discovered, some modules which support tags for process data may be found and identified. In such a case, the node manager 210 checks the user tag manager 87 to determine if a user has explicitly configured tags in the discovered module. If so, those tags are exposed to the user through the OPC server 84, either by polling or exception reporting. The OPC Node Manager 210 may need to make requests to the SDA server 82 in order to instruct it to set up the points in the DCS or to poll values from the modules for the user defined tags. Each of these requests will be screened by the SDA server 82 to ensure that the target module is capable of the requested action, and that it is in a state in which it can service that action. Thus, the user is unable to configure invalid tags in the system that could cause communications problems. A user may manually configure tags for process data that is important to a particular external application in order to ensure that process data is delivered to the external application, since the DCS may be unable to route all process data to a single CIU 34 or may be unable to provide updates for all process data to a single CIU 34 in a timely manner.

The operation of the smart interface system 44 will now be described with regard to the DCS 10. Upon start-up of the smart interface system 44 (and in particular the SDA server 82), the topology finder 85 discovers the topology of the DCS 10 and adds it to the topology model database 88. The topology model database 88 is periodically updated pursuant to a predetermined interval, which is configurable. When the web server application 200 receives a request for data from a particular module (at a particular address) in the DCS 10, this request is forwarded to the topology model database 88 for determination whether the address (loop, node, module etc.) is valid and whether the data requested can be obtained from (i.e., is supported by) the particular module and/or node at the address. If the topology model database 88 determines that the address is valid and the requested data can be obtained from the module at the address, the request is forwarded to the API Access 182, which acts on the request to obtain the data from the module through the API wrapper 196, the API 80 and the CIU 34a, subject to any required throttling. The requested data from the module is then transmitted back to the web server application 200 through the CIU 34a, the API 80, the API wrapper 196 and the API Access 182.

The smart interface system 44 provides a number of benefits. Instead of relying on a user to ensure a valid DCS configuration is present in an interface, the smart interface system 44 uses the automatic discovery of DCS components to self-configure at runtime. This means that DCS devices exposed by the smart interface system 44 have been identified and are actually present. The user has no option to configure tags for or issue commands to devices that are not present or devices that if accessed could cause system disturbances. This also frees the user from the laborious task of manually verifying a DCS configuration, and allows the smart interface system 44 to be quickly deployed with an existing system.

Further, the DCS discovery and self-configuration can be used to block commands that are not supported by any target device in the DCS. This further protects the DCS by preventing a user from issuing an unsupported command to a device, as some commands are supported by only certain models of devices. Before any command to service a user request is submitted to the DCS, a lookup is performed for the target device in the discovered configuration, which includes knowledge of the capabilities of each device. If a command is not supported by the target device, the user request is aborted.

A further benefit of the smart interface system 44 is that the smart interface system 44 throttles requests that result in a load being placed upon the DCS. All requests that pass the validation requirements and result in a command being issued to the DCS are subjected to a throttling mechanism that limits the outstanding user requests to the DCS, and enforces a maximum request rate. New requests that are initiated may be held and delayed by the throttling mechanism in order to satisfy these requirements. This results in an interface system that is further hardened against misbehaving client applications or users who unknowingly or intentionally attempt to configure or use a client application in a manner that would otherwise disrupt the DCS with a flood of supported commands.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. An interface system for connecting an external application to a distributed control system (DCS), the interface system comprising computer readable media having instructions for causing a computer to execute a method comprising:
scanning the DCS to determine its configuration;
using the determined configuration of the DCS to construct a topology model of the DCS;
receiving, from the external application, an external request for data from a module in the DCS; and
determining, using the topology model of the DCS, whether the module is capable of providing the requested data.

2. The interface system of claim 2, wherein the method further comprises:
generating an internal request for data if the module is determined to be capable of providing the requested data; and
sending the internal request for data to the module.

3. The interface system of claim 2, wherein the external request for data includes an address of the module.

4. The interface system of claim 3, wherein the step of determining comprises:
determining whether the address in the external request for data is a valid address in the topology model;
determining the type of module at the address in the topology model; and
determining whether the determined type of module is capable of providing the requested data.

5. The interface system of claim 4, wherein the method determines that the module is capable of providing the requested data if the address in the external request for data is a valid address in the topology model and the type of module at the address in the topology model is capable of providing the requested data.

6. The interface system of claim 2, wherein the external request for data is a first external request for data, the internal request for data is a second internal request for data, and wherein the method further comprises:
receiving, from the external application, a second external request for data from the DCS;
determining, using the topology model of the DCS, whether the DCS is capable of providing the data requested in the second external request for data;
generating a second internal request for data if the DCS is determined to be capable of providing the data requested in the second external request for data;
determining whether a predetermined period of time has elapsed since the first external request for data was received; and
if the predetermined period of time has not elapsed, holding the generated second internal request for data.

7. The interface system of claim 6, wherein the method further comprises:
determining whether the first internal request for data has been sent to the module; and
if the first internal request for data has not been sent to the module, holding the generated second internal request for data.

8. The interface system of claim 1, wherein the method further comprises storing the topology model in a plurality of classes, and wherein read/write locks are placed on objects in each of the classes, each read/write lock on an object preventing the reading of data from the object while changes are being made to the object and vice versa.

9. The interface system of claim 8, wherein the classes comprise a loop class, a node class and a module class, and wherein the DCS comprises a loop, a plurality of nodes on the loop and a plurality of modules in each node, and wherein an object for the loop is stored in the loop class, objects for the nodes are stored in the node class and objects for the modules are stored in the module class.

10. The interface system of claim 1, wherein the interface system is operable to connect the external application to a plurality of distributed control systems.

11. The interface system of claim 1, wherein the external request for data comprises a request for diagnostic data from the module.

12. The interface system of claim 11, wherein the diagnostic data includes data selected from the group consisting of memory usage, error counters, communication metrics, firmware level, program execution metrics, error states and combinations of the foregoing.

13. The interface system of claim 1, wherein the DCS comprises a loop with a plurality of nodes connected thereto, the nodes comprising a plurality of microprocessor-based controllers connected to a communication bus, and wherein the loop comprises a unidirectional, high speed serial data network.

14. The interface system of claim 13, wherein the external request for data is a SOAP message.

15. A method of connecting an external application to a distributed control system (DCS), the method comprising:
scanning the DCS to determine its configuration;
using the determined configuration of the DCS to construct a topology model of the DCS;
receiving, from the external application, an external request for data from a module in the DCS; and
determining, using the topology model of the DCS, whether the module is capable of providing the requested data.

16. The method of claim 15, further comprising:
generating an internal request for data if the module is determined to be capable of providing the requested data; and
sending the internal request for data to the module.

17. The method of claim 16, wherein the external request for data includes an address of the module.

18. The method of claim 17, wherein the step of determining comprises:
determining whether the address in the external request for data is a valid address in the topology model;
determining the type of module at the address in the topology model; and
determining whether the determined type of module is capable of providing the requested data.

19. The method of claim 18, wherein the method determines that the module is capable of providing the requested data if the address in the external request for data is a valid address in the topology model and the type of module at the address in the topology model is capable of providing the requested data.

20. The method of claim 15, wherein the method further comprises storing the topology model in a plurality of classes, and wherein read/write locks are placed on objects in each of the classes, each read/write lock on an object preventing the reading of data from the object while changes are being made to the object and vice versa.
